(19) United States
(12) Patent Application Publication
(10) Pub. No.: US 2015/0302592 A1
(43) Pub. Date: Oct. 22, 2015

(54) GENERATION OF A DEPTH MAP FOR AN IMAGE

(71) Applicant: KONINKLIJKE PHILIPS N.V., EINDHOVEN (NL)

(72) Inventors: WILHELMUS HENDRIKUS ALFONSUS BRULS, EINDHOVEN (NL); MEINDERT ONNO WILDEBOER, EINDHOVEN (NL)

(73) Assignee: KONINKLIJKE PHILIPS N.V., Eindhoven (NL)

(21) Appl. No.: 14/402,257

(22) PCT Filed: Nov. 7, 2013
(86) PCT No.: PCT/IB2013/059964

§ 371 Date: Nov. 19, 2014

Related U.S. Application Data
(60) Provisional application No. 61/723,373, filed on Nov. 7, 2012.

(51) Int. Cl. G06T 7/00

(52) U.S. Cl. CPC G06T 7/0051; G06T 7/0085; G06T 2207/20028; G06T 2207/20228

(57) ABSTRACT

An apparatus for generating an output depth map for an image comprises a first depth processor (103) which generates a first depth map for the image from an input depth map. A second depth processor (105) generates a second depth map for the image by applying an image property dependent filtering to the input depth map. The image property dependent filtering may specifically be a cross-bilateral filtering of the input depth map. An edge processor (107) determines an edge map for the image and a combiner (109) generates the output depth map for the image by combining the first depth map and the second depth map in response to the edge map. Specifically, the second depth map may be weighted higher around edges than away from edges. The invention may in many embodiments provide a temporally and spatially more stable depth map while reducing degradations and artifacts introduced by the processing.

### FIELD OF THE INVENTION

The invention relates to generation of a depth map for an image and in particular, but not exclusively, to generation of a depth map using bilateral filtering.

### BACKGROUND OF THE INVENTION

Three dimensional displays are receiving increasing interest, and significant research in how to provide three dimensional perception to a viewer is undertaken. Three dimensional (3D) displays add a third dimension to the viewing experience by providing a viewer's two eyes with different views of the scene being watched. This can be achieved by having the user wear glasses to separate two views that are displayed. However, as this may be considered inconvenient to the user, it is in many scenarios preferred to use autostereoscopic displays that use means at the display (such as lenticular lenses, or barriers) to separate views, and to send them in different directions where they individually may reach the user's eyes. For stereo displays, two views are required whereas autostereoscopic displays typically require more views (such as e.g. nine views).

As another example, a 3D effect may be achieved from a conventional two-dimensional display implementing a motion parallax function. Such displays track the movement of the user and adapt the presented image accordingly. In a 3D environment, the movement of a viewer's head results in a relative perspective movement of close objects by a relatively large amount whereas objects further back will move progressively less, and indeed objects at an infinite depth will not move. Therefore, by providing a relative movement of different image objects on the two dimensional display dependent on the viewer's head movement a perceptible 3D effect can be achieved.

In order to fulfill the desire for 3D image effects, content is created to include data that describes 3D aspects of the captured scene. For example, for computer generated graphics, a three dimensional model can be developed and used to calculate the image from a given viewing position. Such an approach is for example frequently used for computer games which provide a three dimensional effect.

As another example, video content, such as films or television programs, are increasingly generated to include some 3D information. Such information can be captured using dedicated 3D cameras that capture two simultaneous images from slightly offset camera positions. In some cases, more simultaneous images may be captured from further offset positions. For example, nine cameras offset relative to each other could be used to generate images corresponding to the nine viewpoints of a nine view cone autostereoscopic display.

However, a significant problem is that the additional information results in substantially increased amounts of data, which is impractical for the distribution, communication, processing and storage of the video data. Accordingly, the efficient encoding of 3D information is critical. Therefore, efficient 3D image and video encoding formats have been developed that may reduce the required data rate substantially.

A popular approach for representing three dimensional images is to use one or more layered two dimensional images plus associated depth data. For example, a foreground and background image with associated depth information may be used to represent a three dimensional scene or a single image and associated depth map can be used.

The encoding formats allow a high quality rendering of the directly encoded images, i.e. they allow high quality rendering of images corresponding to the viewpoint for which the image data is encoded. The encoding format furthermore allows an image processing unit to generate images for viewpoints that are displaced relative to the viewpoint of the captured images. Similarly, image objects may be shifted in the image (or images) based on depth information provided with the image data. Further, areas not represented by the image may be filled in using occlusion information if such information is available.

However, whereas an encoding of 3D scenes using one or more images with associated depth maps providing depth information allows for a very efficient representation, the resulting three dimensional experience is highly dependent on sufficiently accurate depth information being provided by the depth map(s).

Various approaches may be used to generate depth maps. For example, if two images corresponding to different viewing angles are provided, matching image regions may be identified in the two images and the depth may be estimated by the relative offset between the positions of the regions. Thus, algorithms may be applied to estimate disparities between two images with the disparities directly indicating a depth of the corresponding objects. The detection of matching regions may for example be based on a cross-correlation of image regions across the two images.

However, a problem with many depth maps, and in particular with depth maps generated by disparity estimation in multiple images, is that they tend to not be as spatially and temporally stable as desired. For example, for a video sequence, small variations and image noise across consecutive images may result in the algorithms generating temporally noisy and unstable depth maps. Similarly, image noise (or processing noise) may result in depth map variations and noise within a single depth map.

In order to address such issues, it has been proposed to further process the generated depth maps to increase the spatial and/or temporal stability and to reduce noise in the depth map. For example, a filtering or edge smoothing or enhancement may be applied to the depth map. However, a problem with such an approach is that the post-processing is not ideal and typically itself introduces degradations, noise and/or artifacts. For example, in cross-bilateral filtering there will be some signal (luma) leakage into the depth map. Although obvious artifacts may not be immediately visible, the artifacts will typically still lead to eye fatigue for longer term viewing.

Hence, an improved generation of depth maps would be advantageous and in particular an approach allowing increased flexibility, reduced complexity, facilitated implementation, improved temporal and/or spatial stability and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an apparatus for generating an output depth map for an image, the apparatus comprising: a first depth processor for generating a first depth map for the image from an input depth map; a second depth processor for generating a second depth map for the image by applying an image property dependent filtering to the input depth map; an edge processor for determining an edge map for the image; and a combiner for generating the output depth map for the image by combining the first depth map and the second depth map in response to the edge map.

The invention may provide improved depth maps in many embodiments. In particular, it may in many embodiments mitigate artifacts resulting from the image property dependent filtering while at the same time providing the benefits of the image property dependent filtering. In many embodiments the generated output depth map may have reduced artifacts resulting from the image property dependent filtering.

The Inventors have had the insight that improved depth maps can be generated by not merely using a depth map resulting from image property dependent filtering but by combining this with a depth map to which image property dependent filtering has not been applied, such as the original depth map.

The first depth map may in many embodiments be generated from the input depth map by means of filtering the input depth map. The first depth map may in many embodiments be generated from the input depth map without applying any image property dependent filtering. In many embodiments, the first depth map may be identical to the input depth map. In the latter case the first processor effectively only performs a pass-through function. This may for example be used when the input depth map already has reliable depth values within objects, but may benefit from filtering near object edges as provided by the present invention.

The edge map may provide indications of image object edges in the image. The edge map may specifically provide indications of depth transition edges in the image (e.g. as represented by one of the depth maps). The edge map may for example be generated (exclusively) from depth map information. The edge map may e.g. be determined for the input depth map, the first depth map or the second depth map and may accordingly be associated with a depth map and through the depth map with the image.

The image property dependent filtering may be any filtering of a depth map which is dependent on a visual image property of the image. Specifically, the image property dependent filtering may be any filtering of a depth map which is dependent on a luminance and/or chrominance of the image. The image property dependent filtering may be a filtering which transfers properties of image data (luminance and/or chrominance data) representing the image to the depth map.

The combining may specifically be a mixing of the first and second depths map, e.g. as a weighted summation. The edge map may indicate regions around detected edges.

The image may be any representation of a visual scene represented by image data defining the visual information. Specifically, the image may be formed by a set of pixels, typically arranged in a two dimensional plane, with image data defining a luma and/or chroma for each pixel.

In accordance with an optional feature of the invention, the combiner is arranged to weigh the second depth map higher in edge regions than in non-edge regions.

This may provide an improved depth map. In some embodiments, the combiner is arranged to decrease a weight of the second depth map for an increasing distance to an edge, and specifically the weight for the second depth map may be a monotonically decreasing function of a distance to an edge.

In accordance with an optional feature of the invention, the combiner is arranged to weigh the second depth map higher than the first depth map in at least some edge regions.

This may provide an improved depth map. Specifically, the combiner may be arranged to weigh the second depth map higher that the first depth map in at least some areas associated with edges than for areas not associated with edges.

In accordance with an optional feature of the invention, the image property dependent filtering comprises a cross bilateral filtering.

This may be particularly advantageous in many embodiments. In particular, a bilateral filtering may provide a particularly efficient attenuation of degradations resulting from depth estimation (e.g. when using disparity estimation based multiple images, such as in the case of stereo content) thereby providing a more temporally and/or spatially stable depth map. Furthermore, the bilateral filtering tends to improve areas wherein conventional depth map generation algorithms tend to introduce errors while mostly only introducing artifacts where the depth map generation algorithms provide relatively accurate results.

In particular, the Inventors have had the insight that cross-bilateral filters tend to provide significant improvements around edges or depth transitions while any artifacts introduced often occur away from such edges or depth transitions. Accordingly, the use of a cross-bilateral filtering is particularly suited for an approach wherein the output depth map is generated by combining two depth maps whereof one is generated by applying a filtering operation.

In accordance with an optional feature of the invention, the image property dependent filtering comprises at least one of: a guided filtering; a cross-bilateral grid filtering; and a joint bilateral upsampling.

This may be particularly advantageous in many embodiments.

In accordance with an optional feature of the invention, the edge processor is arranged to determine the edge map in response to an edge detection process performed on at least one of the input depth map and the first depth map.

This may provide an improved depth map in many embodiments and for many images and depth maps. In many embodiments, the approach may provide more accurate edge detection. Specifically, in many scenarios the depth maps may contain less noise than image data for the image.

In accordance with an optional feature of the invention, the edge processor is arranged to determine the edge map in response to an edge detection process performed on the image.

This may provide an improved depth map in many embodiments and for many images and depth maps. In many embodiments, the approach may provide more accurate edge detection. The image may be represented by luminance and/or chroma values.

In accordance with an optional feature of the invention, the combiner is arranged to generate an alpha map in response to the edge map; and to generate the third depth map in response to a blending of the first depth map and the second depth map in response to the alpha map.

This may facilitate operation and provide for a more efficient implementation while providing an improved resulting depth map. The alpha map may indicate a weight for one of the first depth map and the second depth map for a weighted combination (specifically a weighted summation) of the two depth maps. The weight for the other of the first depth map and the second depth map may be determined to maintain energy or amplitude. For example, the alpha map may for each pixel of the depth maps comprise a value a in the interval from 0 to 1. This value a may provide the weight for the first depth map with the weight for the second depth map being given as 1-α. The output depth map may be given by a summation of the weighted depth values from each of the first and second depth maps.

The edge map and/or the alpha map may typically comprise non-binary values.

In accordance with an optional feature of the invention, the second depth map is at a higher resolution than the input depth map.

The regions may have a predetermined distance from an edge. The border of the region may be a soft transition.

In accordance with an aspect of the invention there is provided a method of generating an output depth map for an image, the method comprising: generating a first depth map for the image from an input depth map; generating a second depth map for the image by applying an image property dependent filtering to the input depth map; determining an edge map for the image; and generating the output depth map for the image by combining the first depth map and the second depth map in response to the edge map.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an apparatus for generating a depth map in accordance with some embodiments of the invention;

FIG. 2 illustrates an example of an image;

FIGS. 3 and 4 illustrate examples of depth maps for the image of FIG. 2;

Figure illustrates examples of depth and edge maps at different stages of the processing of the apparatus of FIG. 1;

FIG. 6 illustrates an example of an alpha edge map for the image of FIG. 2;

FIG. 7 illustrates an example of a depth map for the image of FIG. 2; and

FIG. 8 illustrates an example of generation of edges for an image.

### DETAILED DESCRIPTION OF SOME EMBODIMENTS OF THE INVENTION

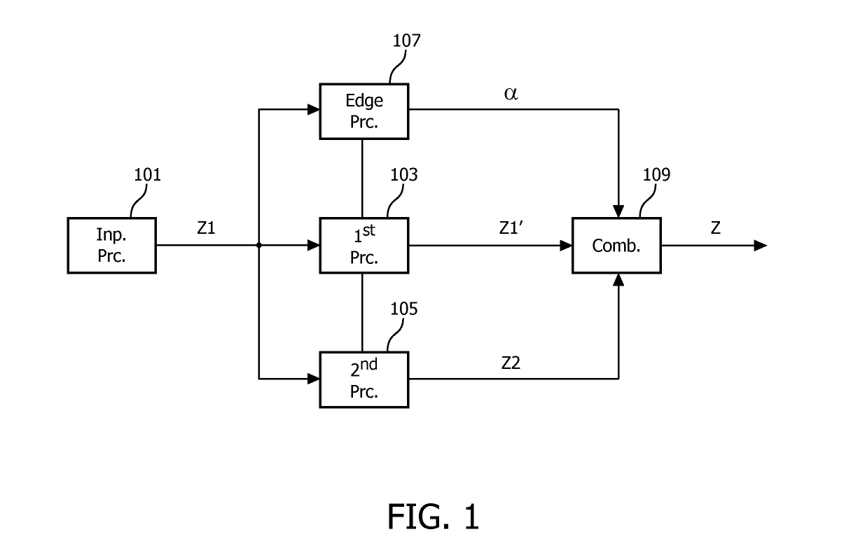

FIG. 1 illustrates an apparatus for generating a depth map in accordance with some embodiments of the invention.

The apparatus comprises a depth map input processor 101 which receives or generates a depth map for a corresponding image. Thus, the depth map indicates depths in a visual image. Typically the depth map may comprise a depth value for each pixel of the image but it will be appreciated that any means of representing depth for the image may be used. In some embodiments, the depth map may be of a lower resolution than the image.

The depth may be represented by any parameter indicative of a depth. Specifically, the depth map may represent the depths by value directly giving an offset in a direction perpendicular to the image plane (i.e. a z-coordinate) or may e.g. be given by a disparity value. The image is typically represented by luminance and/or chroma values (henceforth referred to as chrominance values which denotes luminance values, chroma values or luminance and chroma values).

In some embodiments, the depth map, and typically the image, may be received from an external source. E.g. a data stream may be received comprising both image data and depth data. Such a data stream may be received in real time from a network (e.g. from the Internet) or may for example be retrieved from a medium such as a DVD or BluRay™ disc.

In the specific example, the depth map input processor 101 is arranged to itself generate the depth map for the image. Specifically, the depth map input processor 101 may receive two images corresponding to simultaneous views of the same scene. From the two images, a single image and associated depth map may be generated. The single image may specifically be one of the two input images or may e.g. be a composite image, such as the one corresponding to a midway position between the two views of the two input images. The depth may be generated from disparities in the two input images.

In many embodiments the images may be part of a video sequence of consecutive images. In some embodiments, the depth information may at least partly be generated from temporal variations in images from the same view, e.g. by considering moving parallax information.

As a specific example, the depth map input processor 101, in operation, receives a stereo 3D signal, also called left-right video signal, having a time-sequence of left frames L and right frames R representing a left view and a right view to be displayed to the respective eyes of a viewer for generating a 3D effect. The depth map input processor 101 then generates the initial depth map Z1 by disparity estimation for the left view and the right view, and provides the 2D image based on the left view and/or the right view. The disparity estimation may be based on motion estimation algorithms used to compare the L and R frames. Large differences between the L and R view of an object are converted into high depth values, indicating a position of the object close to the viewer. The output of the generator unit is the initial depth map Z1.

It will be appreciated that any suitable approach for generating depth information for an image may be used and that a person skilled in the art will be aware of many different approaches. An example of a suitable algorithm may e.g. be found in “A layered stereo algorithm using image segmentation and global visibility constraints”. ICIP 2004. Indeed many references to approaches for generating depth information may be found at http://vision.middlebury.edu/stereo/eval/#references.

In the system of FIG. 1, the depth map input processor 101 thus generates an initial depth map Z1. The initial depth map is fed to a first depth processor 103 which generates a first depth map Z1′ from the initial depth map Z1. In many embodiments, the first depth map Z1′ may specifically be the same as the initial depth map Z1, i.e. the first depth processor 103 may simply forward the initial depth map Z1.

A typical characteristic of many algorithms for generating a depth map from images is that they tend to be suboptimal and typically to be of limited quality. For example, they may typically comprise a number of inaccuracies, artifacts and noise. Accordingly, it is in many embodiments desirable to further enhance and improve the generated depth map.

In the system of FIG. 1, the initial depth map Z1 is fed to a second depth processor 105 which proceeds to perform an enhancement operation. Specifically, the second depth processor 105 proceeds to generate a second depth map Z2 from the initial depth map Z1. This enhancement specifically comprises applying an image property dependent filtering to the initial depth map Z1. The image property dependent filtering is a filtering of the initial depth map Z1 which is further dependent on the chrominance data of the image, i.e. it is based on the image properties. The image property dependent filtering thus performs a cross property correlated filtering that allows visual information represented by the image data (chrominance values) to be reflected in the generated second depth map Z2. This cross property effect may allow a substantially improved second depth map Z2 to be generated. In particular, the approach may allow the filtering to preserve or indeed sharpen depth transitions as well as provide a more accurate depth map.

In particular, depth maps generated from images tend to have noise and inaccuracies which are typically especially significant around depth variations. This often results in temporally and spatially instable depth maps. By employing an image property dependent filtering, the use of the image information may typically allow depth maps to be generated which are temporally and spatially significantly more stable.

The image property dependent filtering may specifically be a cross- or joint-bilateral filtering or a cross-bilateral grid filtering

Bilateral filtering provides a non-iterative scheme for edge-preserving smoothing. The basic idea underlying bilateral filtering is to do in the range of an image what traditional filters do in its domain. Two pixels can be close to one another, that is, occupy nearby spatial locations, or they can be similar to one another, that is, have nearby values, possibly in a perceptually meaningful way. In smooth regions, pixel values in a small neighborhood are similar to each other, and the bilateral filter acts essentially as a standard domain filter, averaging away the small, weakly correlated differences between pixel values caused by noise. E.g. at a sharp boundary between a dark and a bright region the range of the values is taken into account. When the bilateral filter is centered on a pixel on the bright side of the boundary, a similarity function assumes values close to one for pixels on the same side, and values close to zero for pixels on the dark side. As a result, the filter replaces the bright pixel at the center by an average of the bright pixels in its vicinity, and essentially ignores the dark pixels. Good filtering behavior is achieved at the boundaries and crisp edges are preserved at the same time, thanks to the range component.

Cross-bilateral filtering is similar to bilateral filtering but is applied across different images/depth map. Specifically, the filtering of a depth map may be performed based on visual information in the corresponding image.

In particular, the cross-bilateral filtering may be seen as applying for each pixel position a filtering kernel to the depth map wherein the weight of each depth map (pixel) value of the kernel is dependent on a chrominance (luminance and/or chroma) difference between the image pixel at the pixel position being determined and the image pixel at the position in the kernel. In other words, the depth value at a given first position in the resulting depth map can be determined as a weighted summation of depth values in a neighborhood area, where the weight for a (each) depth value in the neighborhood depends on a chrominance difference between the image values of the pixels at the first position and of the pixel at the position for which the weight is determined.

An advantage of such cross-bilateral filtering is that it is edge preserving. Indeed, it may provide more accurate and reliable (and often sharper) edge transitions. This may provide improved temporal and spatial stability for the generated depth map.

In some embodiments, the second depth processor 105 may include a cross bilateral filter. The word cross indicates that two different but corresponding representations of the same image are used. An example of cross bilateral filtering can be found in “Real-time Edge-Aware Image Processing with the Bilateral Grid” by Jiawen Chen, Sylvain Paris, Frédo Durand, Proceedings of the ACM SIGGRAPH conference, 2007. Further information can also be found at e.g. http://www.stanford.edu/class/cs448f/lectures/3.1/Fast%20Filtering%20Continued.pdf

The exemplary cross bilateral filter uses not only depth values, but further considers image values, such as typically brightness and/or color values. The image values may be derived from 2D input data, for example the luma values of the L frames in a stereo input signal. Here, the cross filtering is based on the general correspondence of an edge in luma values to an edge in depth.

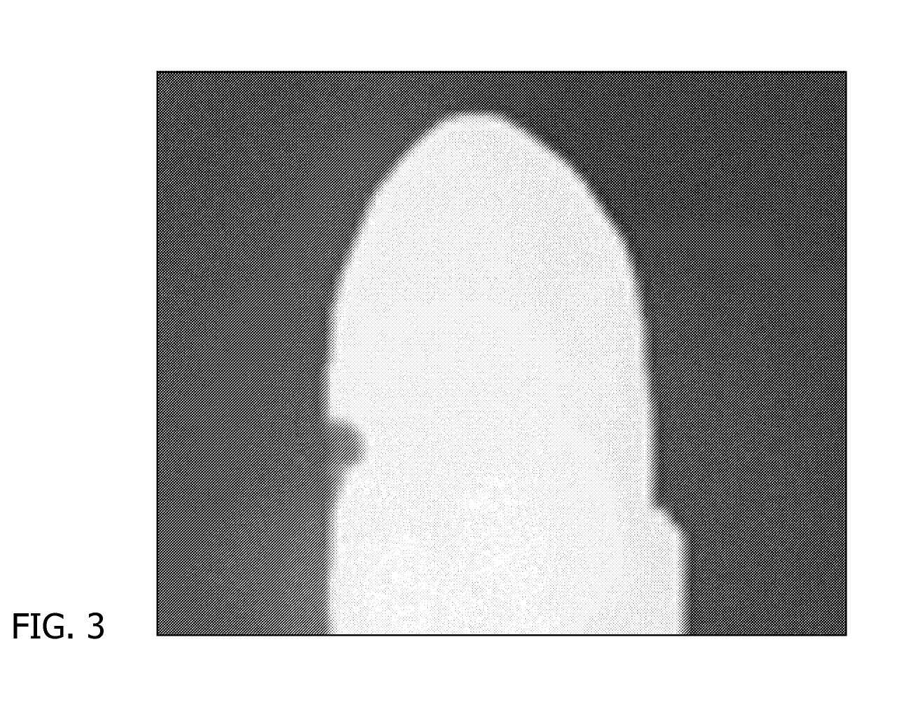

Optionally the cross bilateral filter may be implemented by a so-called bilateral grid filter, to reduce the amount of calculations. Instead of using individual pixel values as input for the filter, the image is subdivided in a grid and values are averaged across one section of the grid. The range of values may further be subdivided in bands, and the bands may be used for setting weights in the bilateral filter. An example of bilateral grid filtering can be found in e.g. the document “Real-time Edge-Aware Image Processing with the Bilateral Grid, by Jiawen Chen, Sylvain Paris, Frédo Durand; Computer Science and Artificial Intelligence Laboratory, Massachusetts Institute of Technology” available from http://groups.csail.mit.edu/graphics/bilagrid/bilagrid_web.pdf. In particular see FIG. 3 of this document. Alternatively, more information can be found in Jiawen Chen, Sylvain Paris, Frédo Durand, “Real-time Edge-Aware Image Processing with the Bilateral Grid”, Proceeding SIGGRAPH '07 ACM SIGGRAPH 2007 papers, Article No. 103, ACM New York, N.Y., USA ©2007 doi>10.1145/1275808.1276506

As another example, the second depth processor 105 may alternatively or additionally include a guided filter implementation.

Derived from a local linear model, a guided filter generates the filtering output by considering the content of a guidance image, which can be the input image itself or another different image. In some embodiments, the depth map Z1 may be filtered using the corresponding image (for example luma) as guidance image.

Guided filters are known, for example from the document “Guided Image Filtering”, by Kaiming He, Jian Sun, and Xiaoou Tang, Proceedings of ECCV, 2010 available from http://research.microsoft.com/en-us/um/people/jiansun/papers/Guidedfilter_ECCV10.pdf

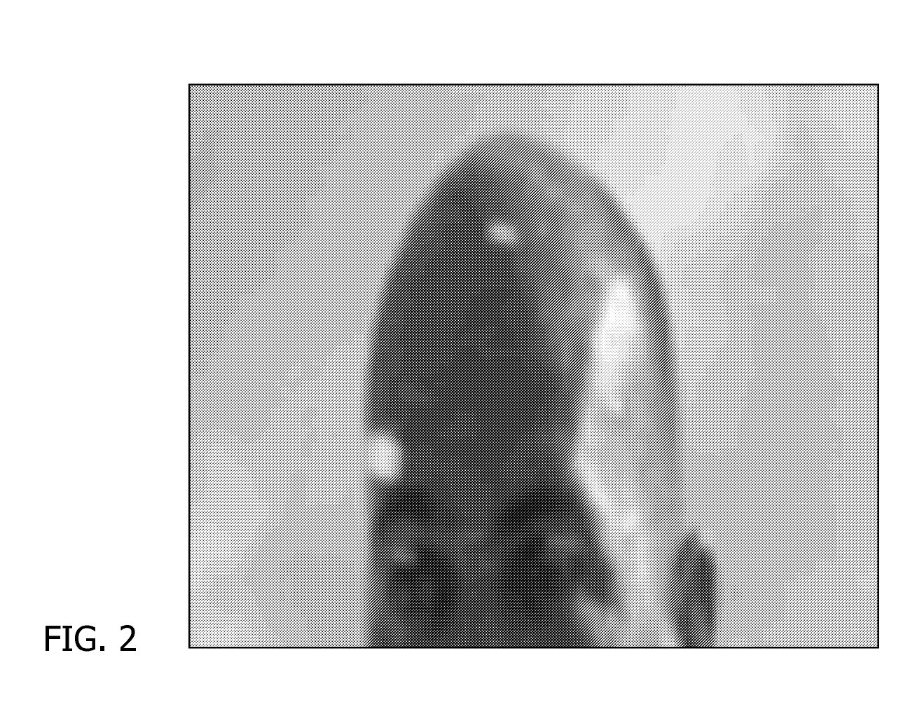

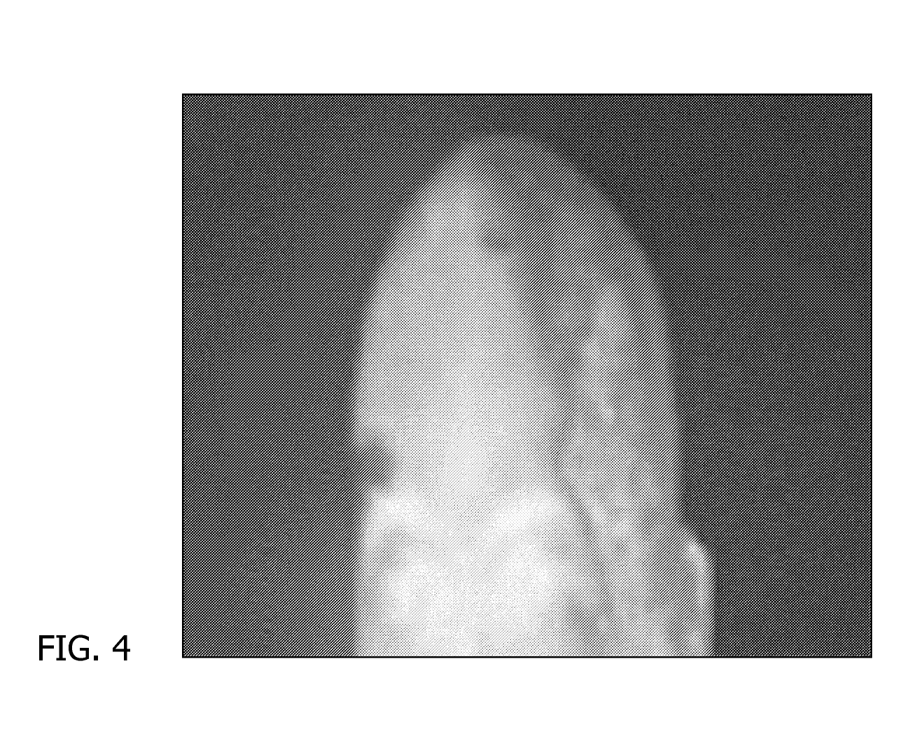

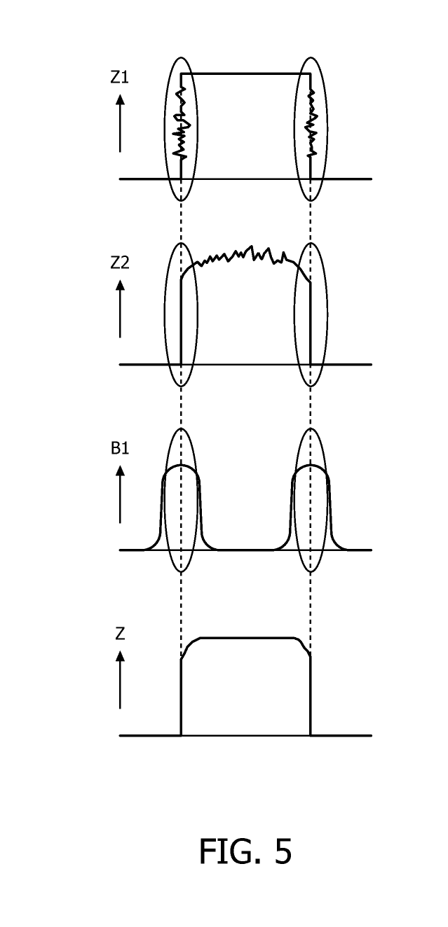

As an example, the apparatus of FIG. 1 may be provided with the image of FIG. 2 and the associated depth map of FIG. 3 (or the depth map input processor 101 may generate the image of FIG. 2 and the depth map of FIG. 3 from e.g. two input images corresponding to different viewing angles). As can be seen from FIG. 3, the edge transitions are relatively rough and are not highly accurate. FIG. 4 shows the resulting depth map following a cross-bilateral filtering of the depth map of FIG. 3 using the image information from the image of FIG. 2. As is clearly seen, the cross-bilateral filtering yields a depth map to closely follows the image edges.

However, FIG. 4 also illustrates how the (cross-)bilateral filtering may introduce some artifacts and degradations. For example, the image illustrates some luma leakage wherein properties of the image of FIG. 2 introduce undesired depth variations. For example, the eyes and eyebrows of the person should be roughly at the same depth level as the rest of the face. However, due to the visual image properties of the eyes and eyebrows being different than the rest of the face, the weight of the depth map pixels are also different and this results in a bias to the calculated depth levels.

In the apparatus of FIG. 1 such artifacts may be mitigated. In particular, the apparatus of FIG. 1 does not use only the first depth map Z1′ or the second depth map Z2. Rather, it generates an output depth map by combining the first depth map Z1′ and the second depth map Z2. Furthermore, the combining of the first depth map Z1′ and the second depth map Z2 is based on information relating to edges in the image. Edges typically correspond to borders of image objects and specifically tend to correspond to edge transitions. In the apparatus of FIG. 1 information of where such edges occur in the image is used to combine the two depth maps.

Thus, the apparatus further comprises an edge processor 107 which is coupled to the depth map input processor 101 and which is arranged to generate an edge map for the image/depth maps. The edge map provides information of image object edges/depth transitions within the image/depth maps. In the specific example, the edge processor 109 is arranged to determine edges in the image by analyzing the initial depth map Z1.

The apparatus of FIG. 1 further comprises a combiner 109 which is coupled to the edge processor 107, the first depth processor 103 and the second depth processor 105. The combiner 109 receives the first depth map Z1′, the second depth map Z2 and the edge map and proceeds to generate an output depth map for the image by combining the first depth map and the second depth map in response to the edge map.

In particular, the combiner 109 may weigh contributions from the second depth map Z2 higher in the combination for increasing indications that the corresponding pixel corresponds to an edge (e.g. for increased probability that the pixels belong to an edge and/or for a decreasing distance to a determined edge). Similarly, the combiner 109 may weigh contributions from the first depth map Z1′ higher in the combination for decreasing indications that the corresponding pixel corresponds to an edge (e.g. for decreased probability that the pixels belong to an edge and/or for an increasing distance to a determined edge).

The combiner 109 may thus weigh the second depth map higher in edge regions than in non-edge regions. For example, the edge map may comprise an indication for each pixel reflecting the degree to which the pixel is considered to belong to (/be part of/be comprised within) an edge region. The higher this indication is, the higher the weighting of the second depth map Z2 and the lower the weighting of the first depth map Z1′ is.

For example, the depth map may define one or more edges and the combiner 109 may decrease a weight of the second depth map and increase a weight of the first depth map for an increasing distance to an edge.

The combiner 109 may weigh the second depth map higher than the first depth map in areas that are associated with edges. For example, a simple binary weighting may be used, i.e. a selection combination may be performed. The depth map may comprise binary values indicating whether each pixel is considered to belong to an edge region or not (or equivalently the depth map may comprise soft values that are thresholded when combining). For all pixels belonging to an edge region, the depth value of the second depth map Z2 may be selected and for all pixels not belonging to an edge region, the depth value of the first depth map Z1′ may be selected.

An example of the approach is illustrated in FIG. 5, which represents a cross section of a depth map, showing an object in front of a background. In the example, the initial depth map Z1 represents a foreground object which is bordered by depth transitions. The generated depth map Z1 indicates object edges fairly well but is spatially and temporally instable as indicated by the markings along the vertical edges of the depth map, i.e. the depth values will tend to fluctuate both spatially and temporally around the object edges. In the example, the first depth map Z1′ is simply identical to the initial depth map Z1.

The edge processor 107 generates an edge map B1 which indicates the presence of the depth transitions, i.e. of the edges of the foreground object. Furthermore, the second depth processor 105 generates the second depth map Z2 using e.g. a cross-bilateral filter or a guided filter. This results in a second depth map Z2 which is more spatially and temporally stable around the edges. However, undesirable artifacts and noise may be introduced away from the edges, e.g. due to luma or chroma leakage.

Based on the edge map, the output depth map Z is then generated by combining (e.g. selection combining) the initial depth map Z1/first depth map Z1′ and the second depth map Z2. In the resulting depth map Z, the areas around edges are accordingly predominantly dominated by contributions from the second depth map Z2 whereas areas that are not proximal to edges are dominated by contributions from the initial depth map Z1/first depth map Z1′. The resulting depth map may accordingly be a spatially and temporally stable depth map but with substantially reduced artifacts from the image dependent filtering.

In many embodiments, the combining may be a soft combining rather than a binary selection combining. For example, the depth map may be converted into/or directly represent an alpha map which is indicative of a degree of weighting for the first depth map Z1′ or the second depth map Z2. The two depth maps Z1 and Z2 may accordingly be blended together based on the alpha map. The edge map/alpha map may typically be generated to have soft transitions, and in such cases at least some of the pixels of the resulting depth map Z will have contributions from both the first depth map Z1′ and the second depth map Z2.

Specifically, the edge processor 107 may comprise an edge-detector which detects edges in the initial depth map Z1. After the edges have been detected, a smooth alpha blending mask may be created to represent an edge map. The first depth map Z1′ and second depth map Z2 may then be combined, e.g. by a weighted summation where the weights are given by the alpha map. E.g. for each pixel, the depth value may be calculated as:

Z=∝·Z2+(1−∝)·Z1′

The alpha/blending mask B1 may be created by thresholding and smoothing the edges to allow a smooth transition between Z1 and Z2 around edges. The approach may provide stabilization around edges while ensuring that away from the edges, noise due to luma/color leaking is reduced. The approach thus reflects the Inventors insight that improved depth maps can be generated, and in particular that the two depth maps have different characteristics and benefits, in particular with respect to their behavior with respect to edges.

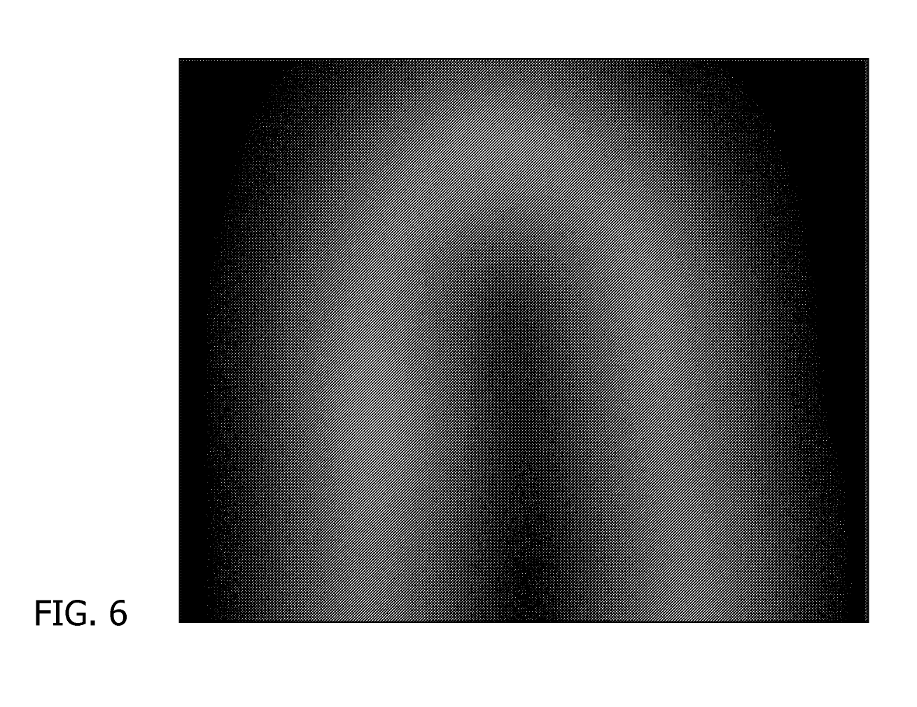

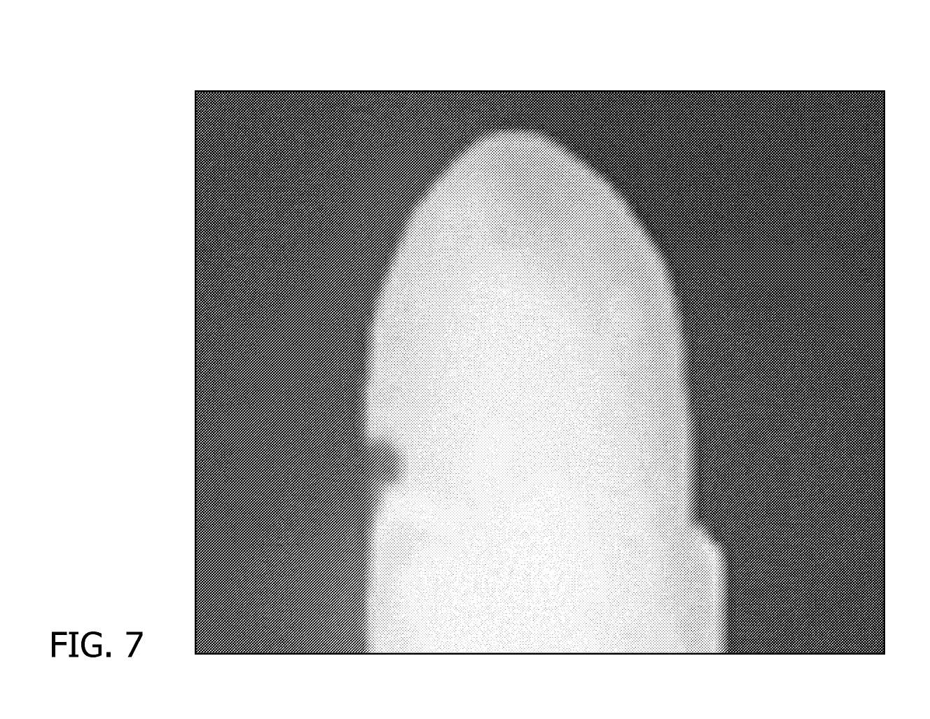

An example of an edge map/alpha map for the image of FIG. 2 is illustrated in FIG. 6. Using this map to guide a linear weighted summation of the first depth map Z1′ and the second depth map Z2 (such as the one described above) leads to the depth map of FIG. 7. Comparing this to the first depth map Z1′ of FIG. 3 and the second depth map Z2 of FIG. 4 clearly shows that the resulting depth map has the advantages of both the first depth map Z1′ and the second depth map Z2.

It will be appreciated that any suitable approach for generating an edge map may be used, and that many different algorithms will be known to the skilled person.

In many embodiments, the edge map may be determined based on the initial depth map Z1 and/or the first depth map Z1′ (which in many embodiments may be the same). This may in many embodiments provide improved edge detection. Indeed, in many scenarios the detection of edges in an image can be achieved by low complexity algorithms applied to a depth map. Furthermore, reliable edge detection is typically achievable.

Alternatively or additionally, the edge map may be determined based on the image itself. For example, the edge processor 107 may receive the image and perform an image data based segmentation based on the luma and/or chroma information. The borders between the resulting segments may then be considered to be edges. Such an approach may provide improved edge detection in many embodiments, for example for images with relatively low depth variations but significant luma and/or color variations.

As a specific example, the edge processor 107 may perform the following operations on the initial depth map Z1 in order to determine the edge map:
1. First the initial depth map Z1 may be downsampled/downscaled to a lower resolution.
2. An edge convolution kernel may be applied to the image, i.e. a spatial “filtering” using an edge convolution kernel may be applied to the downscaled depth map. A suitable edge convolution kernel may for example be:

$$\begin{matrix}- 1 & - 1 & - 1 \\ - 1 & 8 & - 1 \\ - 1 & - 1 & - 1\end{matrix}$$

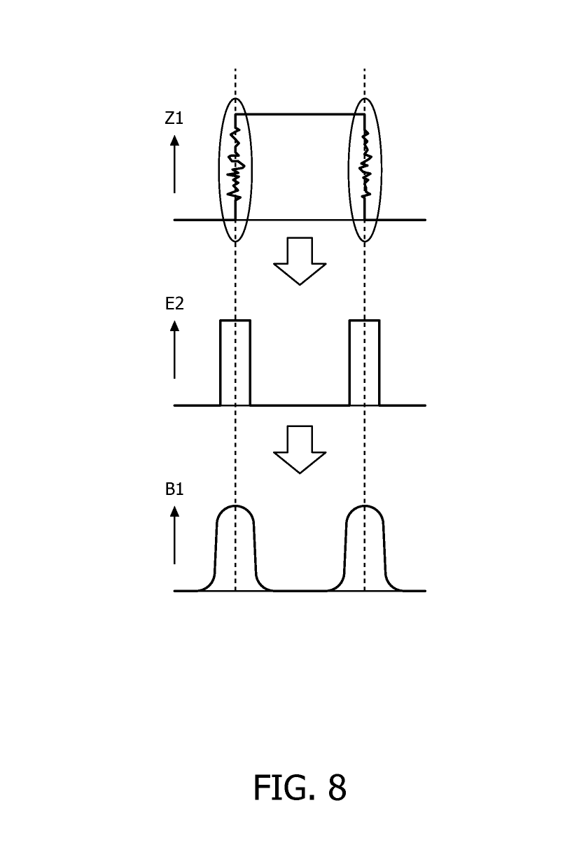

It is noted that for a completely flat area, the result of a convolution with the edge detection kernel will result in a zero output. However, for an edge transition where e.g. the depth values to the right of the current pixel are significantly lower than the depth values to the left will result in a significant deviation from zero. Thus, the resulting values provide a strong indication of whether the center pixel is at an edge or not.
3. A threshold may be applied to generate a binary depth edge map (ref. E2 of FIG. 8).
4. The binary depth edge map may be upscaled to the image resolution. The process of downscaling, performing edge detection, and then upscaling can result in improved edge detection in many embodiments.
5. A box blur filter may be applied to the resulting upscaled depth map followed by another threshold operation. This may result in edge regions that have a desired width.
6. Finally, another box blur filter may be applied to provide a gradual edge that can directly be used for blending the first depth map Z1′ and the second depth map Z2 (ref. E2 of FIG. 8).

The previous description has focused on examples wherein the initial depth map Z1 and the second depth map Z2 have the same resolution. However, in some embodiments they may have different resolutions. Indeed, in many embodiments, the algorithms for generating depth maps based on disparities from different images generate the depth maps to have a lower resolution than the corresponding image. In such examples, a higher resolution depth map may be generated by the second depth processor 105, i.e. the operation of the second depth processor 105 may include an upscaling operation.

In particular, the second depth processor 105 may perform a joint bilateral upsampling, i.e. the bilateral filtering may include an upscaling. Specifically, each depth pixel of the initial depth map Z1 may be divided into sub-pixels corresponding to the resolution of the image. The depth value for a given sub-pixel is then generated by a weighted summation of the depth pixels in a neighborhood area. However, the individual weights used to generate the subpixels are based on the chrominance difference between the image pixels at the image resolution, i.e. at the depth map sub-pixel resolution. The resulting depth map will accordingly be at the same resolution as the image.

Further details of joint bilateral upsampling may e.g. be found in “Joint Bilateral Upsampling” by Johannes Kopf and Michael F. Cohen and Dani Lischinski, and Matt Uyttendaele, ACM Transactions on Graphics (Proceedings of SIGGRAPH 2007), 2007 and U.S. patent application Ser. No. 11/742,325 publication no. 20080267494.

In the previous description, the first depth map Z1′ has been the same as the initial depth map Z1. However, in some embodiments the first depth processor 103 may be arranged to process the initial depth map Z1 to generate the first depth map Z1′. For example, in some embodiments the first depth map Z1′ may be a spatially and/or temporally low pass filtered version of the initial depth map Z1.

Generally speaking, the present invention may be used to particular advantage for improving depth-maps based on disparity estimation from stereo, in particularly so when the resolution of the depth-map resulting from the disparity estimation is lower than that of the left and/or right input images. In such scenarios the use of a cross-bilateral (grid) filter that uses luminance and/or chrominance information from the left and/or right input images to improve the edge accuracy of the resulting depth map has proven to be particularly advantageous.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. An apparatus for generating an output depth map for an image, the apparatus comprising:
a first depth processor for generating a first depth map for the image from an input depth map;
a second depth processor for generating a second depth map for the image by applying an image property dependent filtering to the input depth map;
an edge processor for determining an edge map for the image; and a combiner for generating the output depth map for the image by combining the first depth map and the second depth map in response to the edge map where the combiner is arranged to weigh the second depth map higher in edge regions than in non-edge regions, and edge processor is arranged to determine the edge map in response to an edge detection process performed on the image.

2. (canceled)

3. The apparatus of claim 1 wherein the combiner is arranged to weigh the second depth map higher than the first depth map in at least some edge regions.

4. The apparatus of claim 1 wherein the image property dependent filtering comprises at least one of:
a guided filtering;
a cross-bilateral filtering;
a cross-bilateral grid filtering; and
a joint bilateral upsampling.

5. The apparatus of claim 1 wherein the edge processor is arranged to determine the edge map in response to an edge detection process performed on at least one of the input depth map and the first depth map.

6. (canceled)

7. The apparatus of claim 1 wherein the combiner is arranged to generate an alpha map in response to the edge map; and to generate the third depth map in response to a blending of the first depth map and the second depth map in response to the alpha map.

8. The apparatus of claim 1 wherein the second depth map is at a higher resolution than the input depth map.

9. A method of generating an output depth map for an image, the method comprising:
generating a first depth map for the image from an input depth map;
generating a second depth map for the image by applying an image property dependent filtering to the input depth map;
determining an edge map for the image;
generating the output depth map for the image by combining the first depth map and the second depth map in response to the edge map, and wherein generating the output depth map comprises weighting the second depth map higher in edge regions than in non-edge regions and the edge map is determined in response to an edge detection process performed on the image.

10. (canceled)

11. The method of claim 9 wherein generating the output depth map comprises weighing the second depth map higher than the first depth map in at least some edge regions.

12. The method of claim 9 wherein the image property dependent filtering comprises at least one of:
a guided filtering;
a cross-bilateral filtering;
a cross-bilateral grid filtering; and
a joint bilateral upsampling.

13. (canceled)

14. The apparatus of claim 9 wherein the second depth map is at a higher resolution than the input depth map.

15. A computer program product comprising computer program code means adapted to perform all the steps of claim 9 when said program is run on a computer.
